(19) United States
(12) Patent Application Publication
(10) Pub. No.: US 2003/0232692 A1
(43) Pub. Date: Dec. 18, 2003

(54) Transmission and variable speed system

(76) Inventor: Yung-Tung Chen, Chungli city (TW)

Correspondence Address: BRUCE H. TROXELL, SUITE 1404, 5205 LEESBURG PIKE, FALLS CHURCH, VA, 22041, US

(21) Appl. No.: 10/199,170

(22) Filed: Jul. 22, 2002

(30) Foreign Application Priority Data
Jun. 18, 2002 (TW) 091113266

(51) Int. Cl. F16H 57/08

(52) U.S. Cl. 475/331

(57) ABSTRACT

A transmission and variable speed system includes input gear set and output gear set. The input gear set further includes an input sun gear, input planet gears and an input internal gear ring. The input planet gear is rotationally located in at least an input receiving openings preset in a central input carrier with the input planet gears meshing with the input sun gear and the input gear ring respectively to form the input gear set. The output gear set further includes an output sun gear, at least an output planet gear and an output internal gear ring with the output planet gear being rotationally located in at least an output receiving openings preset in a central output carrier in away of the output planet gear meshing with the output sun gear and the output gear ring respectively to form the output gear set. An input shaft and an output shaft of the transmission and variable speed can be selected from the preceding gears together with a torque difference resulting from the input planet gear and the output gear planet to form a speed ratio control shaft for performing speed changes. Once a speed ratio of the speed ratio control shaft to the input shaft is changed, a variable speed between the input shaft and the output shaft can be changed.

### BACKGROUND OF THE INVENTION

1. Field of the Invention

The present invention relates to a transmission and variable speed system.

2. Description of Related Art

The power transmission or delivery is one of important subjects in the field of mechanical design and it is widely applied. The power transmission can provide an effect of speed change in the process of delivering the power or the so-called application of transmission and the speed change is suitable for machines or traffic tools regardless step speeds or step-less speeds.

Taking the speed change of a traffic tool as an example, a sprocket transmission is applied a bicycle so that size of each sprocket thereof can be changed to perform the speed change. For a motorcycle, the speed change is achieved by way of adjusting the transmission pulleys. For a car or a truck, a variable speed box is applied and the variable speed box contains transmission gears in different sizes to be switched over for speed change. The engine with a clutch is used for speed change so that a clutch is mounted on the power transmission shaft.

As the foregoing, the conventional transmission and speed change devices have a common feature, that is, a change of speed ratio is obtained by way of the same set of transmission component with the same moving way and being performed with exertion forces in reversed directions. However, the step-less transmission force has a limit magnitude during speed change such that the transmission components become wear out greatly and the speed ratio change mechanism has a huge size for a step speed change system and it is necessary to adjust or switch the load side of the power source during speed change. Obviously, it is very complicated and difficult to carry out the speed change.

### SUMMARY OF THE INVENTION

The crux of the present invention resides in that a transmission and variable speed system is provided and comprises input gear set and output gear set. The input gear set further includes an input sun gear, input planet gears and an input internal gear ring. The input planet gear is rotationally located in at least an input receiving openings preset in a central input carrier with the input planet gears meshing with the input sun gear and the input gear ring respectively to form the input gear set. The output gear set further includes an output sun gear, at least an output planet gear and an output internal gear ring with the output planet gear being rotationally located in at least an output receiving openings preset in a central output carrier in away of the output planet gear meshing with the output sun gear and the output gear ring respectively to form the output gear set. An input shaft and an output shaft of the transmission and variable speed can be selected from the preceding gears together with a torque difference resulting from the input planet gear and the output gear planet to form a speed ratio control shaft for performing speed changes. Once a speed ratio of the speed ratio control shaft to the input shaft is changed, a variable speed between the input shaft and the output shaft can be changed.

### BRIEF DESCRIPTION OF THE DRAWINGS

The present invention can be more fully understood by reference to the following detailed description and accompanying drawings, in which:

FIG. 1 is an exploded perspective view of a transmission and variable speed system according to the present invention in an embodiment thereof;

FIG. 2 is an assembled perspective view of a carrier and a sun gear shown in FIG. 1;

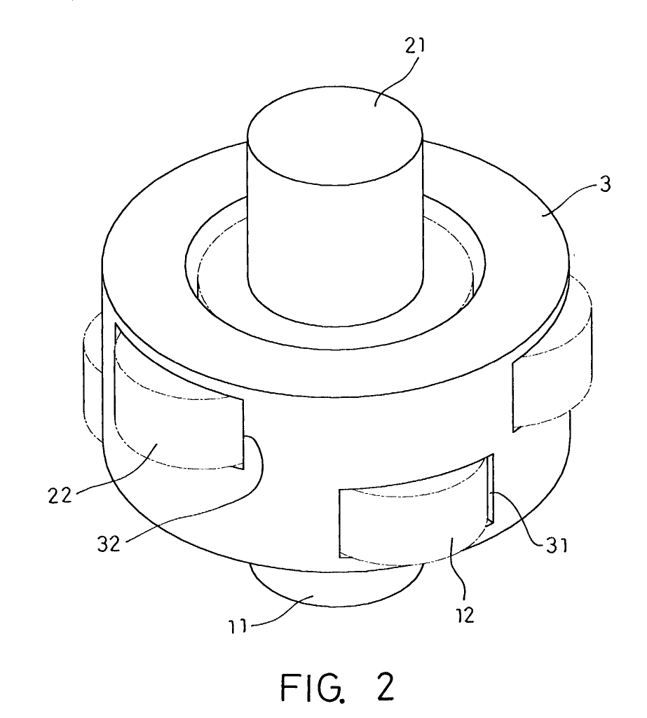

FIG. 3 is a plan view illustrating gears shown in FIG. 1 meshing with each other;

FIG. 4 is a perspective sectional view of the transmission and variable speed system shown in FIG. 1;

FIG. 5 is a diagram illustrating different types of planetary gear system;

FIG. 6 is a chart of speed reduction for a transmission and variable speed system of the present invention in a preferred embodiment thereof; and

FIG. 7 is a chart of torque variation for a transmission and variable speed system of the present invention in a preferred embodiment thereof.

### DETAILED DESCRIPTION OF THE PREFERRED EMBODIMENTS

Basically, a creative concept of the present invention focuses on an adjustment route of speed ratio is set up in addition to the primary transmission route so that output of the driving force can be controlled with an indirect control mode to cause the torque variation and the input shaft and the output shaft are selectively arranged instead of being arranged corresponding to each other.

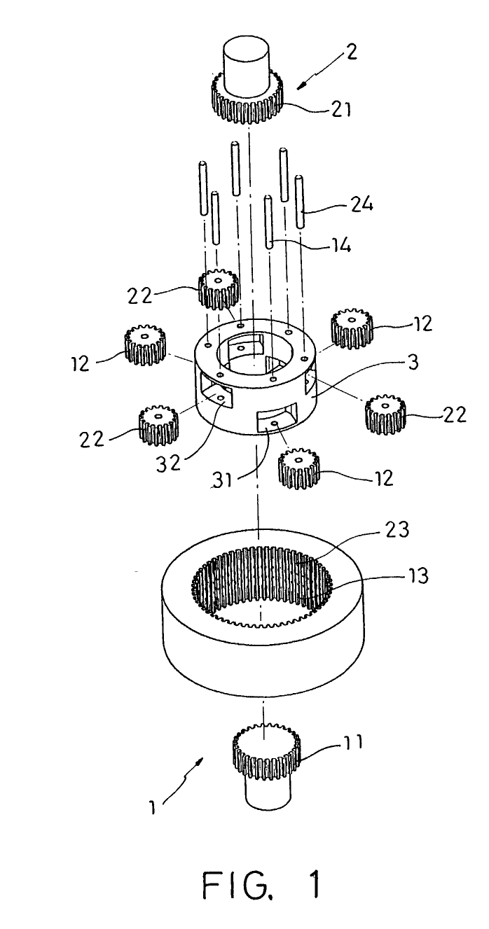

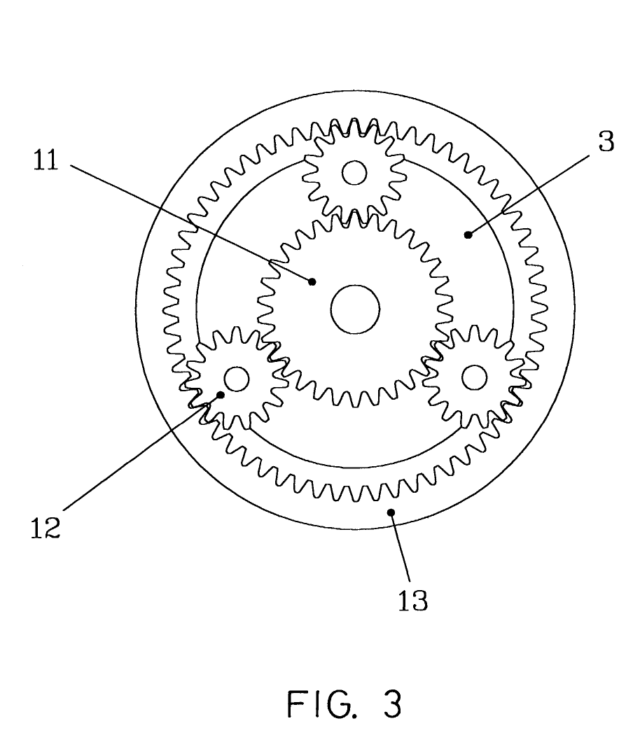

Referring to FIG. 1, two or more gear sets are essentially arranged in the transmission system of the present invention, that is, input gear set 1, output gear set 2 and a carrier 3 are included in the system.

Wherein, the input gear set 1 is composed of an input sun gear 11, at least one planet gear 12 mounted in the carrier 3 and an input internal gear ring 13. In case of two or more planet gears 12 are arranged in the carrier 3, the planet gears 12 can be disposed to space apart an equiangular distance from each other or to space apart from each other symmetrically as the arrangement shown in FIG. 3. That is, the input planet gears 12 are rotationally located in preset receiving openings 31 of the carrier 3 respectively in a way of input spindles 14 being axially pierced through the planet gears respectively so that the planet gears 12 can mesh with the input sun gear 11 and the internal gear ring 13. In order to be covered firmly, the input gear set 1 can be enclosed with a sleeve or a casing and an eccentric or an axial input can be arranged alternatively, however, these are conventional art and no further detail will be described.

The output gear set 2 is composed of an output sun gear 21, an output planet gear 22 and an output internal gear ring 23. The output internal gear ring 23 is integral with the input inner gear ring 13 as a single piece. The output planet gears 22 are rotationally located at preset receiving openings 32 of the carrier 3 in a way of output spindles 24 being axially pierced through the output planet gears 22 respectively. By the same token, the planet gears 22 are arranged to mesh with the output sun gear 21 and the output inner gear ring 23 respectively as the input planet gears 12 being done in FIG. 3.

The carrier 3 has an annular shape and, as the foregoing, the input receiving openings 31 thereof are provided to correspond to the input planet gears 12 and the output receiving openings 32 are provided to correspond to the output planet gears 22 such that the input receiving openings 31 are disposed at a half portion of the carrier 3 and the output receiving openings 32 are disposed at the other half portion of the carrier 3 in a way of the inner receiving openings 31 being space apart the output receiving openings 32 alternately. The preceding input gear ring 13 is integral with the output gear ring 23 so that the number of teeth on the input gear ring 13 can be either the same as those on the output gear ring 23 or different from those on the output gear ring 23. Hence, the input internal gear ring 13 can rotate synchronously with the output internal gear ring 23. It is noted that the input internal gear ring 13 and the output internal gear ring can be arranged separately instead of being joined as a single piece.

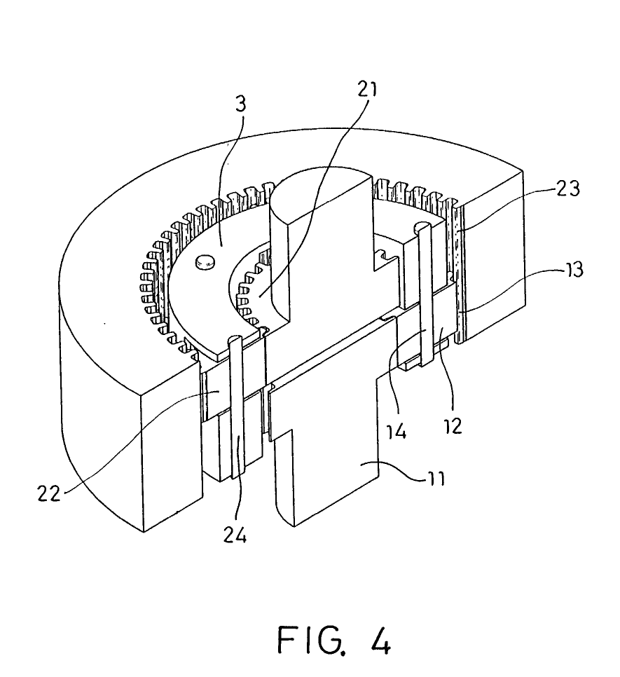

Referring to FIG. 4, the input planet gears 12 and the output planet gears 22 partly extend outward the carrier 3 and freely rotationally mesh with the input sun gear 11, the input internal gear ring 13, the output sun gear 21 and the output internal gear ring 23, respectively.

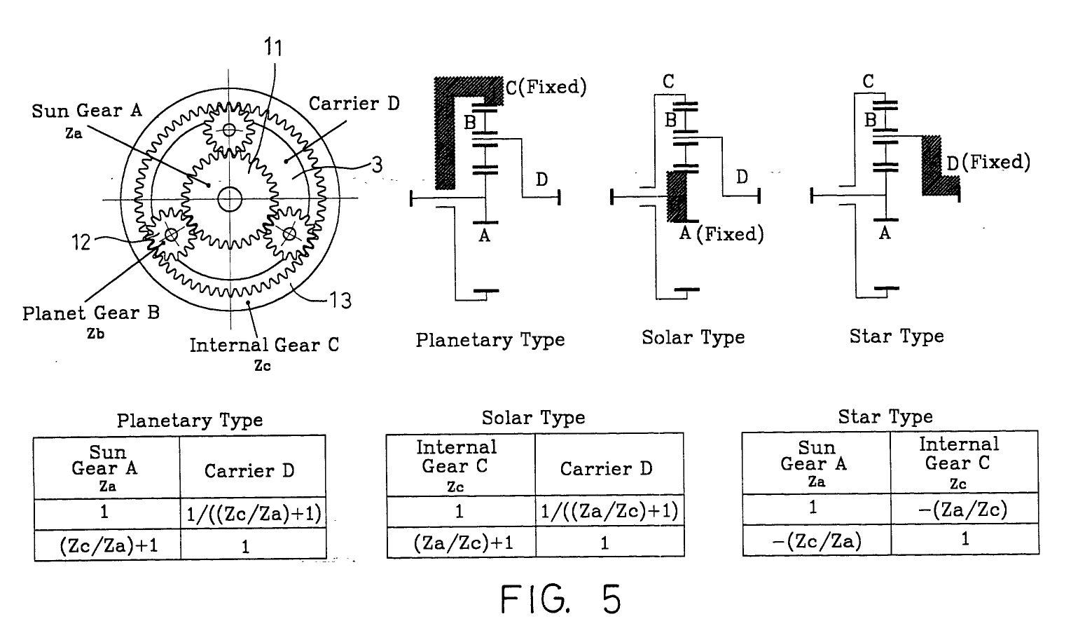

Referring to FIG. 5, it can be learned from the theoretical principle that the planetary gear system can have different arrangements based on different fixing ways: (a) planetary type, i.e., the inner gear ring is stationary with the sun gears being input and the carrier being output; (b) solar type, i.e., the sun gears are stationary with the internal gear ring being input and a shaft attached with the carrier being output; (c) star type, i.e., the carrier is stationary with the planet gears rotating surrounding the sun gears. Hence, the output and input shafts can be arranged with more variable speed devices.

Besides, the speed ratio can be variable with respect to different tooth numbers of each gear. The following table shows formulas for calculating speed ratios for the planetary type gear system.

| | | Sun | | Internal | |
|---|---|---|---|---|---|
| | | Gear A | Planet Gear B | Gear C | Carrier |
| NO. | Description | Za | Zb | Zc | D |
| 1 | Rotate sun gear | +1 | −Za/Zb | −Za/Zc | 0 |
| | A once while | | | | |
| | holding carrier | | | | |
| 2 | System is fixed | +Za/Zc | +Za/Zc | +Za/Zc | +Za/Zc |
| | as a whole | | | | |
| | while rotating | | | | |
| | +(Za/Zb) | | | | |
| 3 | Sum of 1 and 2 | 1 + Za/Zc | Za/Zc − Za/Zc | 0 (fixed) | +Za/Zc |

It can be learned from the preceding table that if the tooth number Za of the sun gear is 16, the tooth number Zb of the planet gear is 16 and the tooth number of the internal gear is 48, the output speed ration via the carrier can be calculated with the formula underneath:_{—}

Speed ration=(Za/Zc)/(1+Za/Zc)=1/((Zc/Za)+1)

Similarly, if the tooth numbers keep unchanged and the solar type gear system is adopted, the speed ratio can be calculated with the formula underneath:

Speed ratio=(−1)/(−(Za/Zc)−1)=1/((Zc/Za)+1)

In this way, the speed ratio is 1/1.3333.

In case of the star type transmission system, the planet gears are not possible to move around except revolving on their own axes due to the carrier being stationary so that the planetary gear system losses the function thereof and it results in an ordinary gear train. The speed ratio=Za/Zc=−⅓ (turning inversely).

Thus, due to the input set being designed to be opposite to the output set, a selection for output or input in the planetary gear system can be variable depending on the desired condition and the tooth number ratio. Comparing to the conventional variable speed system, the present invention offers a better way for selection, that is, it is possible to adopt one of the preceding three types by way of a separation mode in addition to using the preceding types of transmission systems selectively for different inputs and outputs. Furthermore, it is not necessary that both the input and the output have to correspond to each other completely. For instance, the sun gear can be selected as the input and the carrier as the output.

It is known that the rotational speed is inversely proportional to the torque, that is, the greater the rotational speed is the smaller the torque will be and vise versa. The relation varies with the speed ratio arrangement of the gear sets. Because the two gear sets are arranged in the present invention, at least one of the gear sets is set up integrally so that the other set of the gear sets being changed with gear teeth thereof may provide an effect of the variable speed changing with respect to the torque.

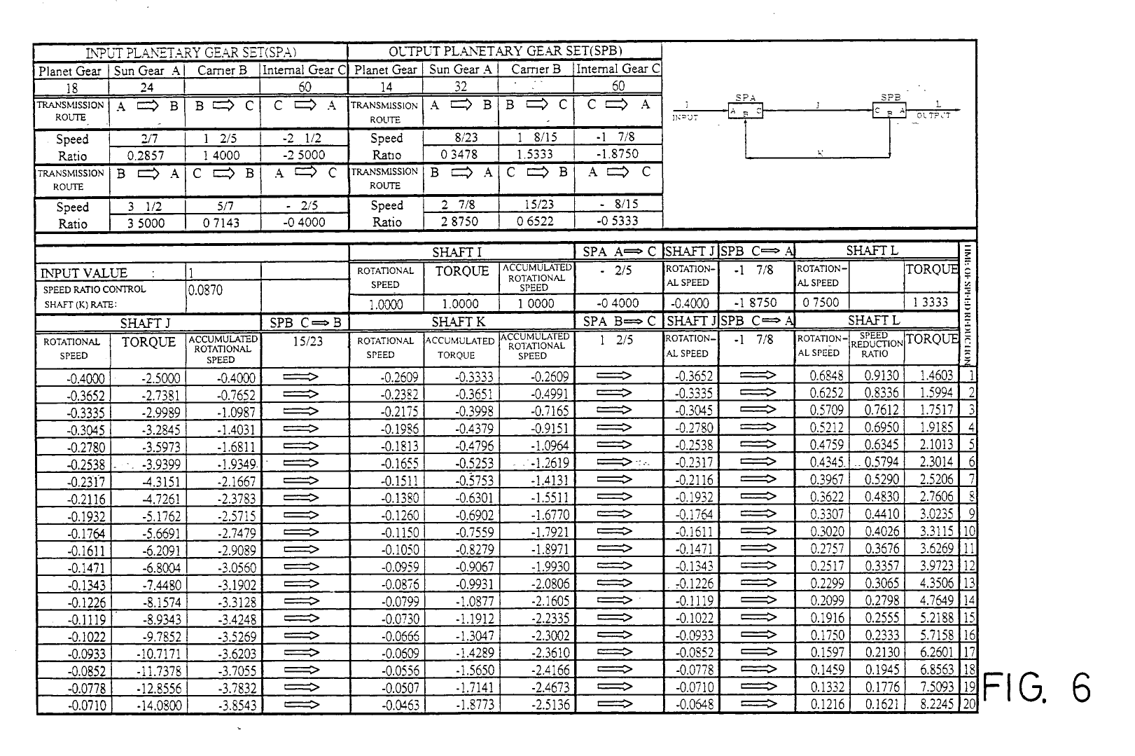

Referring to FIG. 6, an embodiment with regard to the speed change is illustrated. The first set is input gear set (SPA) and the second set is output gear set (SPB), wherein, “A” is designated as tooth number of the sun gear being assigned 24 teeth, “B” is designated as tooth number of the input plant gear 12 being assigned 18 teeth and “C” is designated as the input internal gear ring 13 being assigned 60 teeth. Hence, the output sun gear has 32 teeth, the output planet gear has 14 teeth and the output inner gear ring 23 is integral with the input internal gear ring 13 and has 60 teeth also. Due to the input gear set 1 and the output gear set 2 being commonly arranged, the input shaft is joined to the sun gear “A” to form shaft I and the transmission force can either pass via C (forming a route A to C) or pass via B (forming a route A to B). Similarly, a Shaft J is formed between the output gear set 2 and the output inner gear ring C so that the transmission force reaches the shaft J via the output sun gear 21. Besides, the carriers of the two planetary gear sets are joined together to form shaft K and the shaft K is a control shaft for the speed ratio so that the change of the speed ration of the speed ratio control shaft to the input shaft is possible to change the speed ratio of the input shaft to the output shaft.

All speed ratios between each gear in the transmission system are figured out by way of the preceding formulas and shown at upper left corner of FIG. 6 (SPA is input set and the SPB is output set).

Referring to FIG. 6 again, while the driving force is transmitted to the shaft K via the shaft I, i.e., is transmitted from the input shaft to the shaft K via A and B of SPA, the rotational speed is 0.2857 (2/7) and the torque thereof is 3.500.

If the transmission is from the input shaft I to the shaft K via the shaft J, i.e., from the input shaft to C and B of SPA via A and B of SPA, the rotational speed becomes −0.2609 and the torque thereof becomes −3.833 such that the resultant torque of the shaft K is 3.500+(−3.883) to become −0.3333 and the rotational speed is still −0.2609. In other words, the resultant torque is 8.70% of the original torque −3.8328 so that it is simpler for speed change with regard to dealing with smaller torque and lower rotational speed. In case of the embodiment, the shaft K, which is the carrier for the planet gears, is the speed ratio control shaft and it can be learned from the chart that the torque does not increase greatly even if the rotational speed of the shaft K is getting lower.

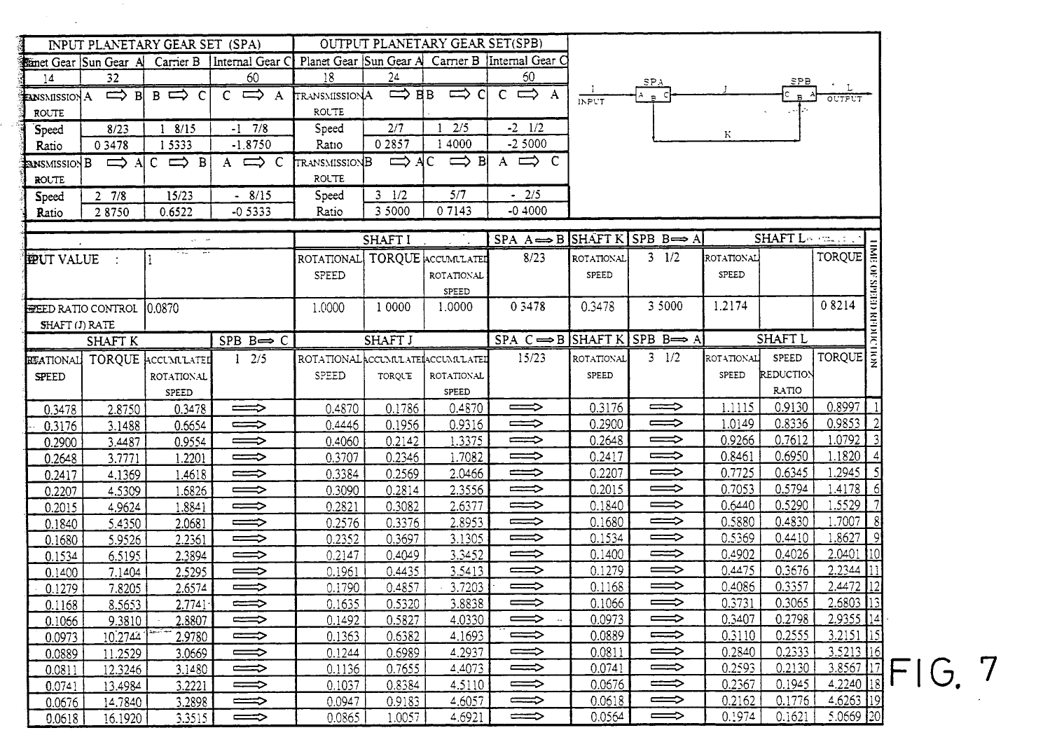

Referring to FIG. 7, a reversed arrangement to FIG. 6 is illustrated. That is, the input gear set 1 and the output gear set 2 are exchanged their tooth numbers each other so that the shaft J becomes the speed ratio control shaft, i.e., the inner gear ring can be the speed ratio control shaft.

In fact, the speed reduction ratio of the transmission system according to the present invention can be set in advance except the embodiments shown in FIGS. 6 and 7. When the tooth number of each gear is changed, the produced output and the speed ration will vary in accordance with the change of the tooth number be different.

Besides, if the bevel gear sets in the conventional differential are used instead of the two gear sets in the transmission system of the present invention, the same effect as the present invention does can be obtained as well. In other words, the input gear set 1 and the output gear set 2 can be replaced with the differential.

It is appreciated from the preceding description that the advantages of the transmission and variable speed system according to the present invention can be summarized hereinafter:

1) The transmission and variable speed system are designed with two or more gear sets so that different combinations can be obtained for complying with the need of different rotational speeds and torques by way of changing tooth numbers.

2) Due to the torque increasing at the time of speed being reduced, an effect of speed change can be reached with the speed being slow down and the torque being increased. Especially, speed reductions in lateral directions of non-main transmission shafts can be obtained more easily.

3) The entire device is small size and simple shape. For instance, the embodiment of the present invention is cylindrical instead of the conventional transmission device, which provides abrupt or huge size, so that it is possible for a product containing the transmission device of the present invention can provide a compact size.

4) The input and output shafts can selectively be the sun gear or the internal gear ring and the carrier is not necessary to be disposed for corresponding to the input and the output such that it is more flexibly selective for the product design.

While the invention has been described with reference to the a preferred embodiment thereof, it is to be understood that modifications or variations may be easily made without departing from the spirit of this invention, which is defined by the appended claims.

What is claimed is:

1. A transmission and variable speed system, comprising
input gear set, further comprising an input sun gear, at least an input planet gear and an input inner gear ring, said input planet gear being rotationally located in at least an input receiving openings preset in a central input carrier and the input planet gears meshing with the input sun gear and the input internal gear ring respectively to form the input gear set;
output gear set, further comprising an output sun gear, at least an output planet gear and an output inner gear ring, said output planet gear being rotationally located in at least an output receiving openings preset in a central output carrier and the output planet gear meshing with the output sun gear and the output internal gear ring respectively to form the output gear set;
wherein, an input shaft and an output shaft of the transmission and variable speed can be selected from the preceding gears together with a torque difference resulting from the input planet gear and the output gear planet to form a speed ratio control shaft for performing speed changes;
whereby, once a speed ratio of the speed ratio control shaft to the input shaft is changed, a variable speed between the input shaft and the output shaft can be changed.

2. The transmission and variable speed system as defined in claim 1, wherein the input planet gear and the output planet gear are located at the carrier by way of a spindle piercing through the carrier respectively.

3. The transmission and variable speed system as defined in claim 1, wherein the speed ratio control shaft at a circumference thereof can be mounted with a step or step-less speed change device.

4. The transmission and variable speed system as defined in claim 1, wherein each of the gears can be the input shaft or the output shaft corresponding to each or non-corresponding to each other.

5. The transmission and variable speed system as defined in claim 1, wherein the input internal gear ring can be integrated with the output internal gear ring; the input sun gear can be integrated with the output sun gear; the input sun gear can be integrated with the input carrier; the input sun gear can be integrated with the output internal gear ring; the input carrier can be integrated with the output carrier; the input carrier can be integrated with the output sun gear; and the input carrier can be integrated with the output internal gear ring.

6. The transmission and variable speed system as defined in claim 1, wherein the input planet gear set and the output gear set can be a differential instead respectively.

7. The transmission and variable speed system as defined in claim 1 can be multiple set in series or in parallel.

8. The transmission and variable speed system as defined in claim 1 can be added to the speed ratio control shaft for speeding up or down the output shaft.

9. The transmission and variable speed system as defined in claim 1, wherein the sun gears, the plant gears, the carriers and the internal gear rings can rotate freely.

10. The transmission and variable speed system as defined in claim 1, wherein the planet gear set can be two sets or more meshing with each other.

11. The transmission and variable speed system as defined in claim 1, wherein an eccentric input or non-eccentric input can be mounted.
